(19) United States
(12) Patent Application Publication
(10) Pub. No.: US 2007/0220150 A1
(43) Pub. Date: Sep. 20, 2007

(54) Source Switching Method for Multimedia Interface

(75) Inventor: Gopal K. Garg, Fremont, CA (US)

Correspondence Address: DAFFER MCDANIEL LLP, P.O. BOX 684908, AUSTIN, TX, 78768, US

(73) Assignee: CYPRESS SEMICONDUCTOR CORP., San Jose, CA (US)

(21) Appl. No.: 11/680,035

(22) Filed: Feb. 28, 2007

Related U.S. Application Data
(60) Provisional application No. 60/777,768, filed on Mar. 1, 2006.

(51) Int. Cl. G06F 3/00; G06F 5/00; G06F 15/173

(52) U.S. Cl. 709/226; 710/38

(57) ABSTRACT

A convenient, low-cost method is provided herein for switching between one or more source devices, which are connected to a sink device via a multimedia interface. According to one embodiment, the method described herein may be used for switching between a plurality of source devices compatible with the High Definition Multimedia Interface (HDMI™) or any other similar audio/video interfaces. In some cases, the method may utilize priority data to connect the source device having the highest priority to the sink. In other cases, the method may allow manual/remote selection to override an original source selection based on priority.

### PRIORITY CLAIM

The present application claims priority to U.S. Provisional Application No. 60/777,768 entitled “Source Switching Method for Low-Cost HDMI Hub,” filed Mar. 1, 2006.

### BACKGROUND OF THE INVENTION

1. Field of the Invention

This invention relates to electronic interface circuits and, more particularly, to a convenient, low-cost method for switching between a plurality of source devices, which are connected to a sink device via a multimedia interface device.

2. Description of the Related Art

The following descriptions and examples are given as background only.

Today, many consumers have three or more audio/video (A/V) components connected together forming an “entertainment system.” For example, a consumer may have a set-top box, A/V receiver and DVD player connected to their TV. In some cases, the A/V components may be connected via a number of different audio and video connection standards—each requiring its own special kind of cabling—so that the simple act of watching TV requires 4-5 remote control commands to be entered on 3 or more remote controls. The typical consumer entertainment system, therefore, suffers from multiple, incompatible connection standards, a complicated tangle of expensive add-on cables hidden behind the display device, and a slew of independent source devices each with its own remote control.

The High Definition Multimedia Interface (HDMI™) is a digital connectivity standard developed to reduce the cable count and ease the process of interconnecting the various A/V devices that make up the typical home entertainment system. The HDMI™ standard combines audio and video in a single digital interface for use with digital television (DTV) sets, digital versatile disc (DVD) players, set-top boxes, game stations, personal computers (PCs), portable devices (e.g., cameras, camcorders and personal media players) and other audiovisual devices.

In general, the HDMI™ standard supports standard, enhanced, or high-definition video plus standard to multi-channel surround-sound audio, all on a single cable and connector. HDMI™ benefits include uncompressed digital audio and video, a bandwidth of up to 10.2 gigabytes per second, and communication between HDMI™-compatible sources and sinks via a single connector (instead of several cables and connectors). As such, HDMI™ eliminates the need for choosing among different audio/video formats, such as RF, composite video, S-video or component video, and optical digital audio or coax-based digital audio. HDMI™ development is overseen by the HDMI™ Working Group that includes Sony, Hitachi, Silicon Image, Philips, and Toshiba as members. Details of the HDMI™ Working Group and current HDMI™ specifications may be found on the group's website (www.hdmi.org).

FIG. 1 is a block diagram of a typical HDMI™ system architecture, including various communication channels that may be established between an HDMI™-compatible source device 100 and an HDMI™-compatible sink device 110. As used herein, an HDMI™ source may include any audiovisual device having an HDMI™ output, while an HDMI™ sink may include any audiovisual device having an HDMI™ input. Examples of HDMI™ sources include receivers, DVD players, set-top boxes, game stations, cameras, camcorders and personal media players. Examples of HDMI™ sinks include TVs, computer monitors and other display devices. Communication channels between the sources and sinks are usually established by way of an HDMI™ connector. The connector can be directly attached to the source/sink device, or indirectly attached via a cable adapter.

As shown in FIG. 1, a typical HDMI™ connector (Type A) may include three Transmission Minimized Differential Signaling (TMDS) channels 120 for transmitting audio, visual and auxiliary data between an HDMI™ transmitter (included within a source) 130 and an HDMI™ receiver (included within a sink) 140. The video pixel clock is transmitted on the TMDS clock channel 150 and is used by the receiver as a frequency reference for data recovery on the three TMDS channels.

The HDMI™ connector may also include a Display Data Channel (DDC) 160 for configuration and status exchange between a single source and a single sink. For example, the DDC may be used by a source to read a sink's Enhanced Extended Display Identification Data (E-EDID), which is stored within EDID ROM 170. In most cases, the EDID may be read upon power-up so that the source can quickly discover the configuration and/or capabilities of the attached sink (such as the video resolutions, timings and audio capabilities supported by the sink). In some cases, the HDMI™ connector may include an optional Consumer Electronics Control (CEC) line 180 to provide high-level control functions between all of the various audiovisual products in a user's environment. When included, the CEC bus enables the attached source devices to communicate bi-directionally with a series of standardized commands that are not manufacture specific.

HDMI™ has become a standard interface in most next generation TVs, as well as other audiovisual products like DVD players, game stations, etc. Unfortunately, most TVs (and other HDMI sinks) have a limited number of HDMI™ inputs for connecting HDMI™ sources thereto. To overcome this problem, an independent multimedia interface (i.e., a stand-alone hub or switch) 210 may be used for connecting multiple source devices 230 to the sink 200, as shown in FIG. 2. The hub often includes manual and/or remote selection means for connecting a particular source device to the sink. Unfortunately, manual switching between source devices is inconvenient for the user. In addition, remote switching increases the cost of the product and usually requires an additional remote control device to be used for switching between the source devices connected to the hub.

Therefore, a need remains for an improved multimedia interface and method for switching between multiple source devices, which are connected to a sink device via the multimedia interface. The multimedia interface may be a stand-alone device (i.e., a hub) or may be integrated within an electronic sink device. Preferably, the improved multimedia interface and method may be used to provide a low-cost source switching solution in a wide range of products, which may or may not support manual/remote switching.

### SUMMARY OF THE INVENTION

The following description of various embodiments of electronic devices, methods and computer-usable carrier mediums is not to be construed in any way as limiting the subject matter of the appended claims.

According to one embodiment, a method is provided herein for establishing a communications path between a source device and a sink device via a multimedia interface. For example, the method may include detecting a number of source devices coupled to the sink device via the multimedia interface. Unlike conventional methods, each of the source devices may include unique priority data assigned thereto for ranking the source devices in a desired order. In some cases, the priority data may be pre-assigned by a manufacturer of the multimedia interface.

In other cases, the priority data may be assigned by a user of the multimedia interface. In one example, the priority data may be assigned by accessing an on-screen menu displayed on the sink device or the multimedia interface. In another example, the priority data may be assigned by activating one or more switches, buttons or keys located on the multimedia interface. Regardless of the particular means used, the method allows the user to change the priority data assigned to the source devices anytime after the step of detecting, as desired.

In some cases, the method may include connecting one of the source devices to the sink device based on the step of detecting. If only one source device is detected, a communications path may be established between the sink device and the detected source device. If more than one source device is detected and manual or remote selection means have not been used to select a particular source device, a communications path may be established between the sink device and a source device having the highest priority assigned thereto. If at least one source device is detected and manual or remote selection means have been used to select a particular source device, a communications path may be established between the sink device and the user-selected source device. If no source devices are detected, the sink output may be disabled or a pre-selected message may be displayed upon the sink output to indicate that an active source device is not currently available.

In some cases, it may be desirable that a default start selection be made prior to remote/manual selection. For example, the step of connecting may include establishing a first communications path between the sink device and a source device having the highest priority ranking assigned thereto if more than one source device is detected. Next, the method may include breaking the first communications path once manual or remote selection means have been used to select a particular source device. Once the particular source device is selected, the method may establish a second communications path between the sink device and the particular source device.

In some cases, the steps of detecting and connecting may be repeated on a periodic basis, a continual basis or upon detecting an optional system reconfiguration. For example, the steps of detecting and connecting may be repeated if: one or more of the source devices originally connected to the multimedia interface is disconnected, one or more additional source devices are connected to the multimedia interface, the priority data assigned to one or more of the source devices changes, or power is removed and subsequently returned to the sink device.

In addition to the method described above, a computer-usable carrier medium is contemplated herein. In some cases, the computer-usable carrier medium may be a storage medium, such as a magnetic or optical disk, a magnetic tape, or a memory. In other cases, the computer-usable carrier medium may be a transmission medium, such as a wire, cable, or wireless medium along which data or instructions are transmitted, or a signal carrying the data or program instructions along such a wire, cable or wireless medium. Regardless, the computer-usable carrier medium may contain/carry program instructions executable for carrying out embodiments of the method described herein and/or data associated with the method.

The computer-usable carrier medium may include a first set of program instructions executable for detecting a number of source devices coupled to a sink device via a multimedia interface, wherein each of the source devices comprises unique priority data assigned thereto for ranking the source devices in a desired order, a second set of program instructions executable for connecting one of the source devices to the sink device (if at least one source device is detected), and a third set of program instructions executable for disabling the sink output or displaying a pre-selected message on the sink to indicate that a source device is not available (if no source devices are detected).

As noted above, the second set of program instructions may be executable for: (i) establishing a communications path between the sink device and a detected source device, if only one source device is detected, (ii) establishing a communications path between the sink device and a source device having the highest priority ranking assigned thereto, if more than one source device is detected and manual or remote selection means have not been used to select a particular source device, and (iii) establishing a communications path between the sink device and a user-selected source device, if at least one source device is detected and manual or remote selection means have been used to select a particular source device.

An electronic device having a multimedia interface coupled thereto for connecting a selected source device to the electronic device is also contemplated herein. In a general embodiment, the multimedia interface may include a storage device for storing program instructions, and a processor coupled to the storage device for executing the program instructions stored therein. The program instructions may include the first, second and third sets of program instructions mentioned above.

In one embodiment, the multimedia interface may be a High Definition Multimedia Interface (HDMI™) having a number of HDMI™ input ports for connecting a plurality of HDMI™-compatible source devices thereto. In this embodiment, the first set of program instructions may be adapted to determine the number of source devices connected to the multimedia interface by accessing a pin associated with each HDMI™ input port. In a preferred embodiment, the number of source devices may be detected by sensing a voltage level present on an input power pin associated with each HDMI™ input port.

In some cases, the multimedia interface may be integrated within the electronic device. In other cases, the multimedia interface may be a stand-alone interface coupled to the electronic device via a cable. In general, the electronic device may be selected from a group comprising televisions, computer monitors and other display devices. The source devices coupled to the electronic device may include any number and combination of source devices selected from a group comprising receivers, amplifiers, DVD players, set-top boxes, game stations, cameras, camcorders, personal media players and other audiovisual devices.

### BRIEF DESCRIPTION OF THE DRAWINGS

Other objects and advantages of the invention will become apparent upon reading the following detailed description and upon reference to the accompanying drawings in which:

FIG. 1 is a block diagram of an HDMI™ system architecture, including various communication paths that may be established between a source device and a sink device;

FIG. 2 is a block diagram illustrating how one or more source devices may be coupled to a sink device via a multimedia interface;

FIG. 3 is a flowchart diagram illustrating one embodiment of a method for establishing a communications path between a source device and a sink device;

FIG. 4 is a flowchart diagram illustrating another embodiment of a method for establishing a communications path between a source device and a sink device;

FIG. 5A is a schematic diagram illustrating one manner in which one or more source devices may be coupled to one or more sink devices via an HDMI™ hub and the cables and connectors associated therewith;

FIG. 5B is a schematic diagram illustrating an exemplary back panel view of an HDMI™ hub, according to one embodiment;

FIG. 5C is a schematic diagram illustrating an exemplary front panel view of an HDMI™ hub, according to one embodiment;

FIG. 5D is a block diagram illustrating exemplary components included within an HDMI™ hub, according to one embodiment;

FIG. 6 is a schematic diagram illustrating one manner in which priority data may be assigned to one or more source devices by accessing an on-screen menu on a sink device;

FIG. 7A is a table illustrating the pin assignments on a Type A HDMI™ connector; and

FIG. 7B is a table illustrating the pin assignments on a Type B HDMI™ connector.

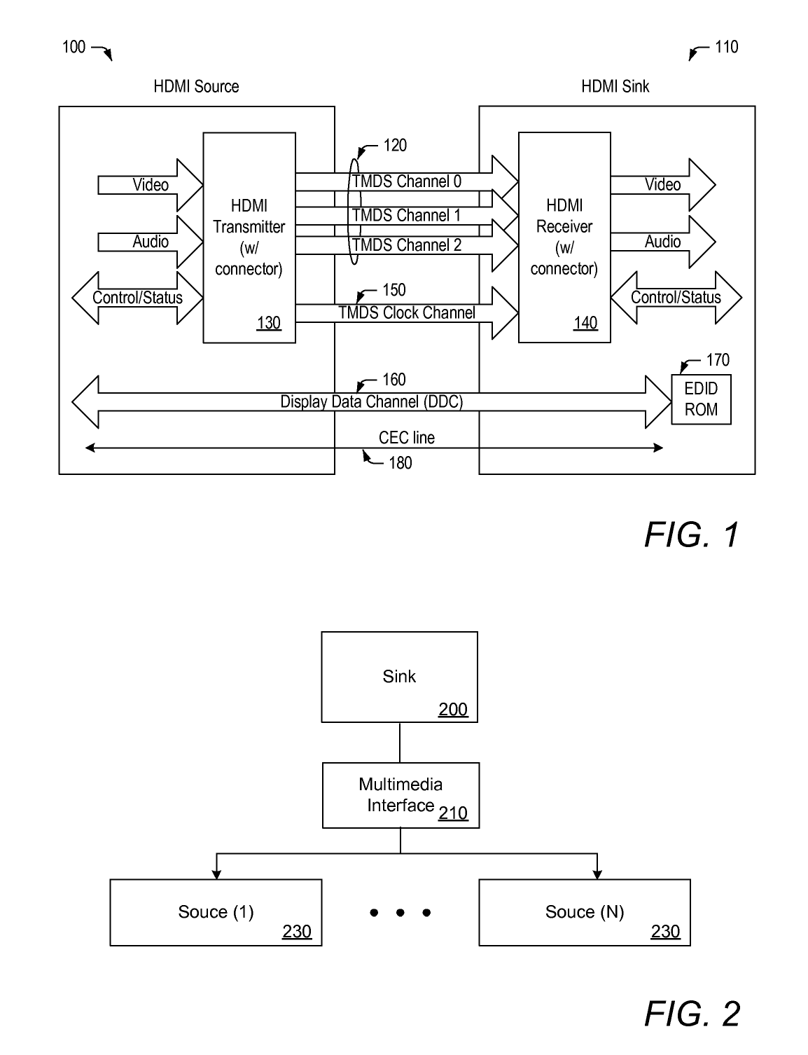

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF PREFERRED EMBODIMENTS

Most HDMI™ sink devices have a limited number of input ports for connecting HDMI™ source devices (such as receivers, DVD players, set-top boxes, game stations, cameras, camcorders and personal media players) thereto. In some cases, a user may wish to connect more source devices than a sink is capable of supporting. In such cases, the user may utilize a separate multimedia interface (i.e., a stand-alone “hub” or “switch”) for connecting multiple source devices to the sink. The hub typically includes a fixed number of HDMI™ input ports for connecting a number of source devices to the sink. In some cases, the hub may include more than one HDMI™ output port for connecting the source devices to more than one sink. Regardless of the number of input and output ports, the hub also includes the necessary hardware/software for establishing a communications path between the sink and a chosen source device.

In the past, a user had to select a particular source device via the manual or remote selection means associated with the hub. For example, a user could select a particular source device by controlling a manual switch or button located on the front access panel of the hub. However, manual selection may be inconvenient for the user, and therefore, not desired at all times. If remote selection is supported by the hub, the user could use a remote control device to select the source from a remote location. Unfortunately, remote selection increases the cost of the product by requiring additional circuitry (e.g., an IR detector and controllers) and adding yet another remote control to the user's collection.

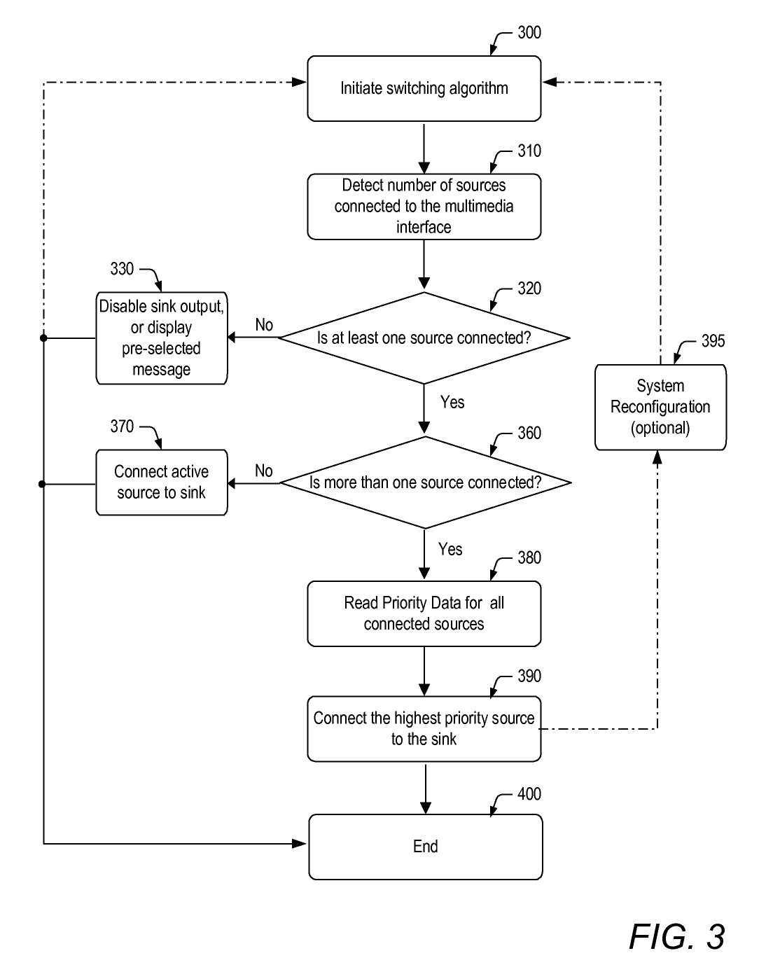

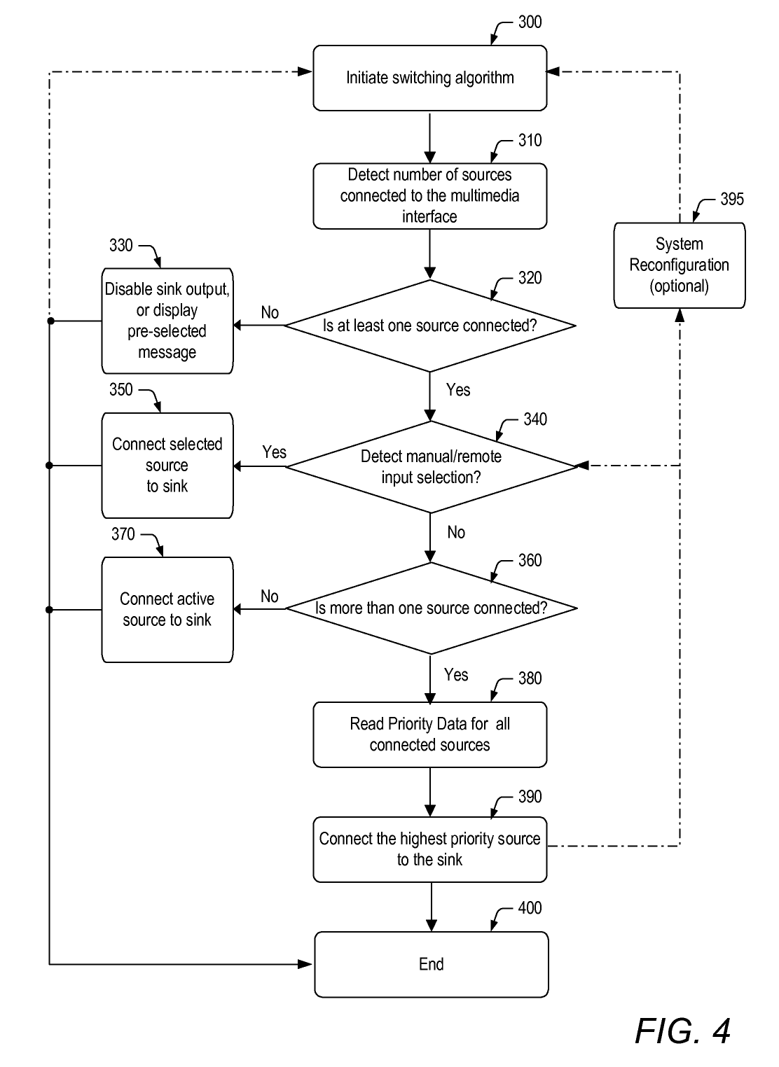

Therefore, a need remains for an improved method for switching between a plurality of source devices coupled to a sink device via a multimedia interface. Exemplary embodiments of improved source switching methods are shown in FIGS. 3 and 4. As described in more detail below, the source switching methods disclosed herein may improve upon conventional methods by providing a convenient, low-cost means for switching between multiple source devices connected to the multimedia interface.

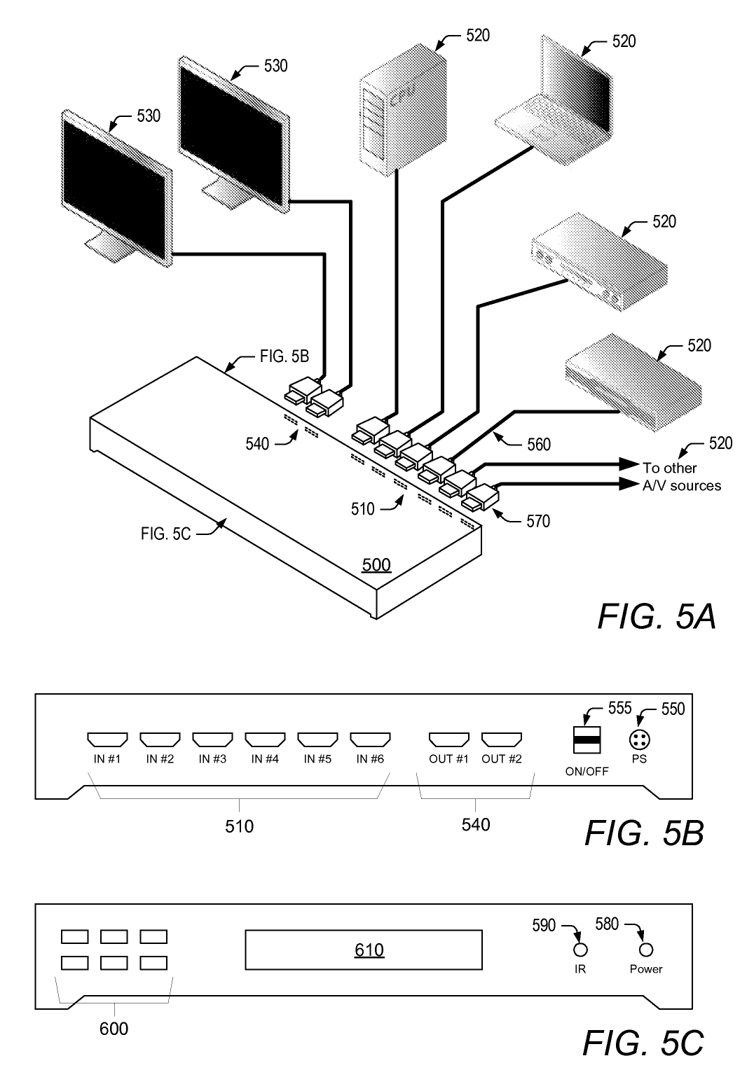

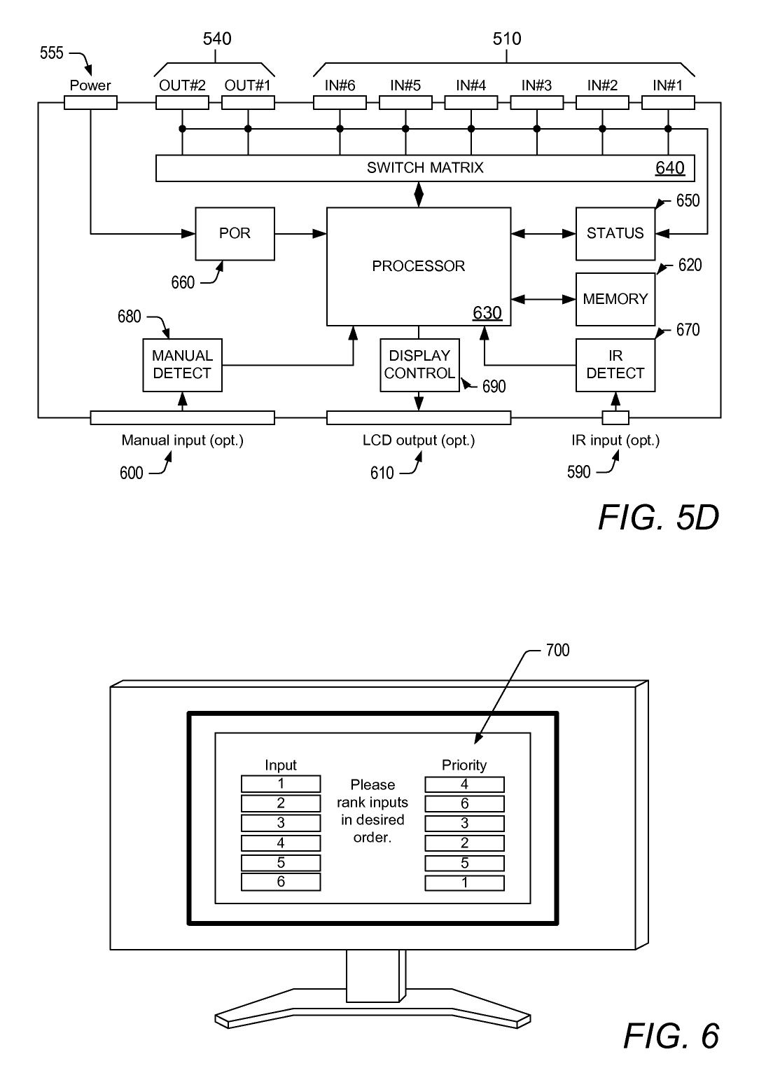

In some embodiments, the improved source switching methods may be incorporated within a stand-alone multimedia interface, such as the HDMI™ hub (500) shown in FIGS. 5A-D. However, the methods described herein are not limited to stand-alone hubs and may be applied to integrated multimedia interfaces, such as those found within audio/video decoders and display devices (e.g., computer monitors and TVs). Although described in the context of HDMI™, the methods set forth below can be extended to other display interfaces, which may use different protocols/standards for connecting multiple source devices to the sink. Generally speaking, the methods described herein may be applied to substantially any multimedia interface capable of detecting a source, one example of which is the Serial Advanced Technology Attachment (SATA) interface.

As one advantage, the improved source switching methods can be used within a variety of products (e.g., hubs, display devices with integrated hub capabilities, etc.), which may or may not support manual/remote switching between source devices. If manual/remote switching is not supported or enabled, the source switching method of FIG. 3 may be used to provide a convenient, low-cost means for automatically selecting the source device with the highest priority setting. However, if manual/remote switching is supported/enabled, the source switching method of FIG. 4 may be used to select a particular source device upon power-up, or alternatively, to override an automatic source selection that was originally made based on priority. Other advantages will become apparent in light of the discussion provided below.

FIG. 3 illustrates one embodiment of an improved source switching method that may be used to establish a communications path between an HDMI™-compatible source device and an HDMI™-compatible sink device. As noted above, FIG. 3 illustrates one embodiment of the improved source switching method when manual/remote selection is not supported by (or enabled within) the HDMI™ interface.

In some embodiments of the invention, one or more steps (not shown) may be performed before the switching algorithm is initiated (in step 300). For example, a number of HDMI™ source devices may be connected to the appropriate input ports of an HDMI™ hub before the algorithm is initiated. A number of HDMI™ sink devices may also be connected to the appropriate output ports of the HDMI™ hub. An HDMI™ hub having six input ports and two output ports is shown in FIGS. 5A-5D. However, the methods described herein are not limited to a stand-alone hub having a particular number of input ports and output ports. In general, an HDMI™ hub in accordance with the present method may be configured for supporting any number of HDMI™-compatible source and sink devices.

In some cases, priority data may also be assigned to the source devices before the switching algorithm is initiated (in step 300). In some embodiments, a user may be responsible for assigning programmable priority data to the source devices connected to the hub. Example embodiments of user-programmable priority data will be described in more detail below in reference to FIGS. 5C-D. In other embodiments, the priority data may be pre-assigned by a manufacturer of the hub. For example, a manufacturer may utilize software commands or one-time programmable fuses to assign priority data to a number of commonly used audio/visual devices. Regardless of the manner in which the priority data is assigned, the priority data may be stored within the hub. For example, the priority data may be stored within a number of programmable registers, flash memory or any other type of storage elements accessible by the switching algorithm. The priority data may then be used by the switching algorithm to select the highest priority source device when more than one source is connected to the hub and manual/remote selection is not supported or currently enabled.

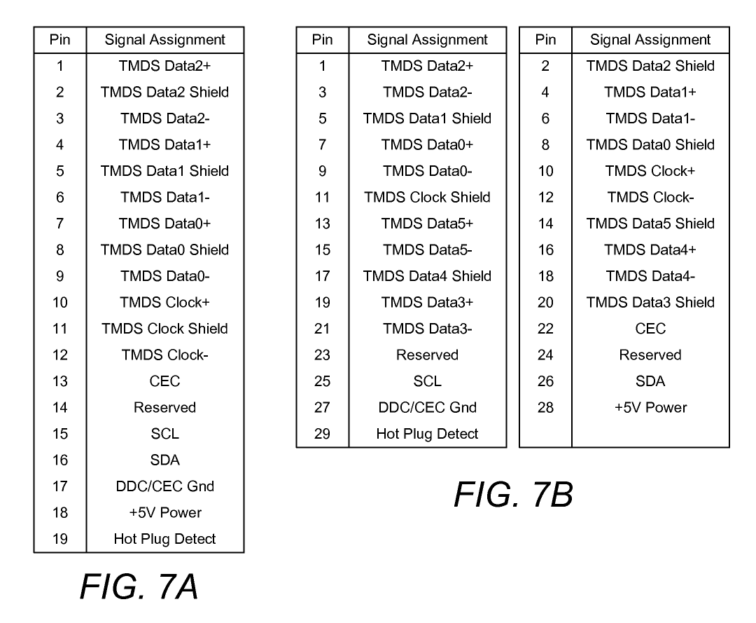

Once the switching algorithm is initiated (step 300), the method may detect the number of HDMI™ source devices connected to the HDMI™ hub (step 310). In one preferred embodiment of the invention, the number of source devices may be detected by accessing an input power pin associated with each HDMI™ input port. According to version 1.2a of the HDMI™ specification, the input power pin (e.g., the +5V pin) is pin #18 on Type A connectors (FIG. 7A) and pin #28 on Type B connectors (FIG. 7B). In one example, the method may “access” the input power pins by sensing the voltage level present on each pin. In some cases, a relatively high voltage level (e.g., near +5V) may indicate the presence of an active HDMI™ input port (and thus, a connected HDMI™ source). Likewise, a relatively low voltage level (e.g., near 0V) may indicate the presence of an inactive HDMI™ input port. The number of active HDMI™ input ports indicates the number of source devices actively connected to the HDMI™ hub.

In particular, the sink may be responsible for determining the number of active source devices connected to the hub. For example, the sink may detect the voltage level present on each input power pin to determine which input ports are active. When an active input is detected, the hot plug detect (HPD) signal associated with the active port may be pulled high to signal to the source that it can now communicate with the sink. Before communication begins, the source may detect the sink's capabilities by using the Display Data Channel (DDC) 160 to read the Enhanced Extended Display Identification Data (E-EDID) stored within EDID ROM 170 (see, FIG. 1). Communication may then be tailored in accordance with the configuration and/or capabilities of the sink (such as the video resolutions, timings and audio capabilities supported by the sink).

However, the step of detecting (step 310) is not limited to sensing the voltage level on the input power pins in all embodiments of the invention. In alternative embodiments, the number of source devices may be detected by accessing one or more additional pins and/or by sensing an active cable connection, source connection or the presence of clock/data signals, etc. However, additional circuitry may be required to detect the presence of signals other than those supplied to the input power pins. The additional circuitry may slightly increase the cost and board space consumption over the preferred embodiment mentioned above, and therefore, may not be desired in all cases.

The remainder of the switching algorithm generally depends on the number of source devices detected in the previous step. If no source devices are detected (in step 320), the output of the sink device may be disabled, or a pre-selected message may be displayed on the sink output (in step 330) to notify the user that a source device is not available (i.e., no active source devices are currently connected to the hub). If only one source device is detected (in steps 320 and 360), a communications path may be established between the sink device and the detected source device (in step 370) by connecting the active input port to an output port of the hub. If more than one source device is detected (in step 360), the method may read the priority data associated with all active input ports (in step 380) and select the highest priority source device to be connected to the sink (in step 390).

If at least one source device is detected, the status of the HDMI™ pins may be reported to a host processor in an optional step of the method (not shown). For example, status information may be stored within one or more programmable status registers (see FIG. 5D). In some cases, the host processor may read the status information to determine whether an input port is active or inactive. In some cases, the host processor may read the status information to determine the input port(s) that are currently selected (i.e., which input ports are currently mapped to an output port), as well as the input port to output port connectivity (i.e., which input port is mapped to which output port). In some cases, the status information stored on-chip may help the user make decisions about priority, if the priority settings are not pre-assigned by the manufacturer of the hub.

In some cases, the method may end (in step 400) after connecting the appropriate source device to the sink (if at least one source device is available), after disabling the sink output or after displaying a pre-selected message (if no source devices are available). In other cases, the method may re-initiate the switching algorithm on a periodic basis, a continual basis, or upon detecting an optional system reconfiguration (as indicated by the dotted lines between steps 390 and 300 and optional method step 395). This may allow the user to reconfigure the HDMI™ source devices (e.g., connect/disconnect one or more sources to/from the hub, change the priority data assigned to the connected source devices, etc.) on the fly and as needed. In some cases, the system may be “reconfigured” (in step 395) simply when power is removed and subsequently returned to the source or sink device. When power is returned, method steps 300-400 may be repeated to verify that the appropriate source device is connected to the appropriate sink.

The method shown in FIG. 3 utilizes the priority data to connect the highest priority source device to the sink. The method does not require/support manual or remote override, and therefore, offers the most cost-effective solution for switching between multiple source devices connected to the hub. In some cases, the priority data may be pre-assigned to the source devices by a manufacturer of the hub. However, the user must have the option to modify the priority data in order to connect other source devices to the sink. In some cases, the user may modify the priority data by accessing an on-screen menu displayed on the sink device, as shown in FIG. 6. This may keep costs low by allowing the priority data to be changed via a remote control or other selection means provided with the sink.

FIG. 4 illustrates another embodiment of an improved method that may be used to establish a communications path between an HDMI™-compatible source device and an HDMI™-compatible sink device. Many of the steps shown in FIG. 4 are identical to the ones shown in FIG. 3 and described in detail above. For the sake of brevity, similar steps indicated with like reference numerals will not be further discussed herein.

As noted above, FIG. 4 illustrates one embodiment of a source switching method when manual and/or remote selection of the source devices is supported and currently enabled. If at least one source device is detected (in step 320), the method of FIG. 4 may detect whether or not the user has selected a particular source device via manual or remote selection means (in step 340). For example, the method may detect an active IR port for remote selection, or manipulation of a manual switch for manual selection of a particular source device. If manual/remote selection has been made, the selected source device is connected to the sink (in step 350) by connecting the appropriate input port to an output port of the hub. If manual/remote selection has not been made, however, the method may continue as previously discussed by determining if more than one source device is connected to the hub (in steps 360-400). If more than one source device is detected, the method may connect the highest priority source device, as discussed above in reference to FIG. 3.

In some cases, the method may select the highest-priority source device (step 390) as a default start selection before the user has a chance to select an alternative source device via the remote/manual selection means. For instance, a source device having the highest priority may be automatically selected upon system power-up by performing steps 300-390 of the current method before any remote/manual selection can be made. However, remote/manual selection can be made anytime thereafter by continually detecting whether or not remote/manual selection has been made (via the dotted lines extending between steps 390 to 340). In other words, the method shown in FIG. 4 allows remote/manual selection to override any priority-based auto-selection means.

The method shown in FIG. 4 differs from the previous method by allowing a user to select a particular source device via manual or remote selection means. The user-selected source device may override a source selection automatically chosen based on priority. In some cases, manual selection means (e.g., switches, buttons or keys) may be preferred in order to keep costs low (e.g., the hub would not need the additional circuitry and remote control required for remote selection). In addition to selecting a particular source device, the manual selection means may be used to modify the priority settings assigned to the source devices, as described below in reference to FIG. 5C.

In other cases, the additional circuitry and remote control required for remote selection may be provided along with the hub. In addition to selecting a particular source device, the remote selection means may be used to modify the priority settings assigned to the source devices by accessing an on-screen menu displayed on the sink device (see, FIG. 6) or on the hub itself (e.g., on an optional LCD panel, as shown in FIG. 5C). Although remote selection tends to increase costs over manual selection, remote selection may provide the user with a greater degree of programmability and convenience.

As noted above, the source switching methods of FIGS. 3 and 4 may be incorporated within a stand-alone or integrated multimedia interface. One embodiment of a stand-alone multimedia interface or “hub” is shown in FIGS. 5A-D. Although an integrated multimedia interface is not illustrated for the purpose of brevity, the improved source switching methods may be integrated within a sink device, in at least one embodiment of the invention.

As shown in FIGS. 5A and 5B, stand-alone HDMI™ hub 500 may include a plurality of input ports (510) for connecting a plurality of source devices (520) to one or more sink devices (530) via one or more output ports (540). In the particular embodiment shown, HDMI™ hub 500 includes six input ports (510) and two output ports (540) for connecting HDMI™-compatible sources to HDMI™-compatible sinks. However, the methods described above are not limited to a particular number of input and output ports and may be applied to substantially any multimedia interface capable of detecting a source and having at least one output port and at least two input ports.

An exemplary back panel view of HDMI™ hub 500 is shown in FIG. 5B. The back panel may generally include a number of input ports (510) and a number of output ports (540), in addition to a power supply port (550), an optional power supply switch (555) and other potential input/output ports (not shown). A single HDMI™ cable (560) and connector (570) is used to connect each source and sink device to the HDMI™ hub (500). A major advantage of HDMI™ is that the single cable/connector (560/570) can be used to replace the numerous cables and connectors typically needed to connect audio/visual devices in the home entertainment system. For example, in the case of a SACD audio capable DVD player, a single HDMI™ cable (560) and connector (570) can replace up to 10 other connections (e.g., 3 for analog component video, 1 for optical or coax digital audio and 6 for the 5.1 multi-channel analog audio outputs).

In general, the HDMI™ connector (570) may be one of two types (e.g., Type A or Type B), as set forth in the current HDMI™ specification (see, www.hdmi.org). The main difference between Type A and B connectors is that Type A connectors include 19 pins for transmitting HDMI™ signals between HDMI™-compatible devices, while Type B connectors use 29 pins. Type B connectors are also larger than Type A connectors and are generally used to support high resolution displays (e.g., high-resolution computer monitors) requiring dual link bandwidth. The signal assignments for Type A and Type B connectors are shown in FIGS. 7A and 7B.

An exemplary front panel view of HDMI™ hub 500 is shown in FIG. 5C. In some cases, the front panel may include a power switch (580) for activating/deactivating hub HDMI™ 500. In other cases, the switch may be replaced by an LED (580) to indicate that power has been applied to or removed from the hub. In such cases, the power switch may be removed from the hub entirely, or moved to the back panel of the hub (see, e.g., optional power switch 555 of FIG. 5B).

In some cases, the front panel may include remote selection means for connecting a particular source device to the sink. For example, an IR input port (590) may be included on the front panel for receiving optical commands transmitted from an IR remote control. The optical commands may be detected via additional circuitry included within the hub (e.g., IR detect circuitry 670 of FIG. 5D). In some cases, the source device selected by the remote selection means may be displayed on the front panel of the hub via optional LCD panel 610 or optional LED lights (not shown).

In some cases, the front panel may include manual selection means for connecting a particular source device to the sink in addition, or alternative to, the remote selection means mentioned above. For example, the front panel may include one or more switches, buttons or keys (600) for connecting a particular source device to the sink. A user may actuate one of the manual selection means, or a combination of the manual selection means, to select a particular source device. In some cases, actuation may be detected by additional circuitry included within the hub (e.g., manual detect circuitry 680 of FIG. 5D). In one embodiment, the front panel may include one switch, button or key (600) for each input port included on the back panel of the hub. However, manual selection is not limited to the number of input ports supported, and may be alternatively achieved with a substantially greater or lesser number of switches, buttons or keys. In some cases, the source device selected by the manual selection means may be displayed on the front panel of the hub via optional LCD panel 610 or optional LED lights (not shown).

In some embodiments, the manual/remote selection means provided on the front panel of the hub may be used to assign priority data to the connected source devices. In one example, a user may depress a series of buttons (600) on the front panel of the hub (500) to assign priority data to the connected source devices. In another example, a user may assign priority data by transmitting a series of optical commands to the IR input port (590) of the hub (500). In such an example, the user may transmit the optical commands using a remote control device supplied with the hub. Regardless of the particular means used, the priority assignment chosen for each source device may be displayed on optional LCD panel 610, in at least one embodiment of the invention.

In other embodiments, priority data may be assigned by accessing an on-screen menu displayed on the sink device. One embodiment of an exemplary on-screen menu (700) is illustrated in FIG. 6. The on-screen menu is displayed on a computer monitor or flat-panel TV in the embodiment of FIG. 6. However, the on-screen menu may be displayed on any sink device having suitable display capabilities. It is also worth noting that the on-screen menu is not limited to the particular layout shown in FIG. 6. In addition to the input port number and existing priority ranking, the on-screen menu may sometimes include other information or instructions to help the user rank the source devices in a desired order. For example, the on-screen menu may indicate the total number of input ports, the input ports that are currently active, and the current mapping between input and output ports (i.e., which source devices are connected to which output ports, such as input port #3 to output port #1).

FIG. 5D represents one embodiment of possible components that may be included within HDMI™ hub 500. As noted above, the improved source switching methods may be embodied as program instructions stored within the hub. In some cases, a non-volatile storage device (620) may be included within the hub (500) for storing the program instructions and priority settings required to implement the methods disclosed herein. The priority settings may include default settings and/or user-selected settings. Examples of suitable non-volatile storage include, but are not limited to flash memory, Read-Only-Memory (ROM) and various programmable versions thereof (e.g., EPROM, EEPROM).

In other cases, the hub (500) may include both volatile storage (not shown) and non-volatile storage (620). For example, the program instructions and default priority settings from the manufacturer may be stored within the non-volatile storage device (620). The volatile memory could be used for storing the user's priority preferences. In one example, the default and user-selected priority settings could be displayed on the on-screen menu at the same time. This would enable a user to select the default factory settings, or enter his/her own preferences into volatile memory, at any time.

In some cases, a processor (630) may be coupled to the storage device (620) for executing the program instructions. For example, the processor may be coupled to a switch matrix (640) for connecting a particular input port 510 (and associated source device) to a particular output port 540 (and associated sink device) based on the outcome of the source switching method. In one example, the processor may execute a first set of program instructions for detecting a number of source devices coupled to the input ports of the hub (500). As noted above, the first set of program instructions may determine the number of source devices connected to the hub by sensing a voltage level present on a pin associated within each input port (510). In a preferred embodiment, the number of source devices may be detected by sensing the voltage level present on the +5V input power pin (e.g., pin #18 on Type A connectors and pin #28 on Type B connectors).

Once the number of source devices is determined, the processor (630) may execute a second set of program instructions for connecting a particular one of the source devices to the sink. If only one source device is detected, a communications path may be established between the sink device and the detected source device. If more than one source device is detected and manual/remote selection means have not been used to select a particular source device, a communications path may be established between the sink device and the source device with the highest priority ranking. If more than one source device is detected and manual/remote selection means has been used to select a particular source device, a communications path may be established between the sink device and the user-selected source device. If no sources are detected by the first set of program instructions, the processor (630) may execute a third set of program instructions for disabling the sink output or displaying a message upon the sink indicating that no sources are currently available.

In some cases, the processor (630) may be coupled to other hub components for performing other functions. For example, the processor may be coupled for: (i) reading the status of the input/output ports stored within status register 650, (ii) detecting a power-on condition via optional power switch 555 and power-on-reset (POR) circuit 660, (iii) detecting remote selection of a source device/priority setting via IR port 590 and IR detect circuitry 670, and/or (iv) detecting manual selection of a source device/priority setting via manual selection means 600 and manual detect circuitry 680. In some cases, the processor (630) may also be coupled for controlling the information displayed on optional LCD panel 610 via display controller 690.

Embodiments of an improved source switching method (FIGS. 3-4) and multimedia interface (FIGS. 5A-D) incorporating the improved methods have now been described. However, it is important to note that the multimedia interface shown in FIGS. 5A-D represents only one embodiment of a suitable interface in which the improved source switching methods of FIGS. 3 and 4 may be utilized. In other words, the improved source switching methods (and advantages provided thereby) are not limited to the multimedia interface explicitly shown herein. In lieu of the stand-alone hub design of FIGS. 5A-D, the improved source switching methods may be executed within an integrated multimedia interface included within an electronic sink device (e.g., a computer monitor or TV having integrated hub capabilities). In some embodiments, a suitable multimedia interface may not include all of the components specifically shown in FIG. 5D, or may include one or more additional components not specifically shown therein. As such, the embodiments shown in FIGS. 5A-D are provided for illustrative purposes only.

It will be appreciated to those skilled in the art having the benefit of this disclosure that this invention is believed to provide a convenient, low-cost method for switching between one or more source devices connected to a sink device via a multimedia interface. Further modifications and alternative embodiments of various aspects of the invention will be apparent to those skilled in the art in view of this description. It is intended that the following claims be interpreted to embrace all such modifications and changes and, accordingly, the specification and drawings are to be regarded in an illustrative rather than a restrictive sense.

What is claimed is:

1. A method for establishing a communications path between a source device and a sink device via a multimedia interface, the method comprising:
detecting a number of source devices coupled to the sink device via the multimedia interface, wherein each of the source devices comprises unique priority data assigned thereto for ranking the source devices in a desired order; and
connecting one of the source devices to the sink device based on said detecting.

2. The method as recited in claim 1, wherein the step of connecting comprises:
establishing a communications path between the sink device and a detected source device, if only one source device is detected;
establishing a communications path between the sink device and a source device having the highest priority ranking assigned thereto, if more than one source device is detected and manual or remote selection means have not been used to select a particular source device; and
establishing a communications path between the sink device and a user-selected source device, if at least one source device is detected and manual or remote selection means have been used to select a particular source device.

3. The method as recited in claim 1, further comprising displaying a pre-selected message to indicate that a source device is not available, if no source devices are detected during the step of detecting.

4. The method as recited in claim 1, wherein if more than one source device is detected, the step of connecting comprises:
establishing a first communications path between the sink device and a source device having the highest priority ranking assigned thereto;
breaking the first communications path once manual or remote selection means have been used to select a particular source device; and
establishing a second communications path between the sink device and the particular source device.

5. The method as recited in claim 1, wherein prior to the step of detecting, the method comprises:
connecting one or more source devices to the multimedia interface; and
assigning the priority data to the one or more source devices.

6. The method as recited in claim 5, wherein the priority data is assigned by a manufacturer of the multimedia interface.

7. The method as recited in claim 5, wherein the priority data is assigned by a user of the multimedia interface.

8. The method as recited in claim 7, wherein the step of assigning the priority data comprises accessing an on-screen menu displayed on the sink device or the multimedia interface.

9. The method as recited in claim 7, wherein the step of assigning the priority data comprises activating one or more switches, buttons or keys located on the multimedia interface.

10. The method as recited in claim 7, wherein anytime after the step of detecting, the method comprises changing the priority data assigned to the source devices, as desired by the user.

11. The method as recited in claim 10, further comprising repeating the steps of detecting and connecting if:
one or more of the source devices originally connected to the multimedia interface is disconnected;
one or more additional source devices are connected to the multimedia interface;
the priority data assigned to one or more of the source devices changes; or
power is removed and subsequently returned to the sink device.

12. A computer-usable carrier medium, comprising:
first program instructions executable for detecting a number of source devices coupled to a sink device via a multimedia interface, wherein each of the source devices comprises unique priority data assigned thereto for ranking the source devices in a desired order; and
second program instructions executable for connecting one of the source devices to the sink device based on said detecting, wherein said connecting comprises:
establishing a communications path between the sink device and a detected source device, if only one source device is detected; and
establishing a communications path between the sink device and a source device having the highest priority ranking assigned thereto, if more than one source device is detected and manual or remote selection means have not been used to select a particular source device.

13. The computer-usable carrier medium as recited in claim 12, wherein said connecting further comprises establishing a communications path between the sink device and a user-selected source device, if at least one source device is detected and manual or remote selection means have been used to select a particular source device.

14. The computer-usable carrier medium as recited in claim 12, further comprising third program instructions executable for displaying a pre-selected message to indicate that a source device is not available, if no source devices are detected by the first program instructions.

15. An electronic device having a multimedia interface coupled thereto for connecting a selected source device to the electronic device, wherein the multimedia interface comprises:
a storage device for storing program instructions; and
a processor coupled to the storage device for executing the program instructions stored therein, wherein the program instructions comprise:
a first set of program instructions executable for detecting a number of source devices coupled to the electronic device via the multimedia interface, wherein each of the source devices comprises unique priority data assigned thereto for ranking the source devices in a desired order; and
a second set of program instructions executable for connecting a select one of the source devices to the electronic device based on said detecting.

16. The electronic device as recited in claim 15, wherein the second set of program instructions are further executable for:
establishing a communications path between the electronic device and a detected source device, if only one source device is detected;
establishing a communications path between the electronic device and a source device having the highest priority ranking assigned thereto, if more than one source device is detected and manual or remote selection means have not been used to select a particular source device; and
establishing a communications path between the electronic device and a user-selected source device, if at least one source device is detected and manual or remote selection means have been used to select a particular source device.

17. The electronic device as recited in claim 16, wherein the program instructions further comprise a third set of program instructions executable for displaying a message upon the electronic device indicating that no sources are available, if no sources are detected during the step of detecting.

18. The electronic device as recited in claim 15, wherein the multimedia interface comprises a High Definition Multimedia Interface (HDMI™) having a number of HDMI™ input ports for connecting a plurality of source devices thereto.

19. The electronic device as recited in claim 18, wherein the first set of program instructions are configured to determine the number of source devices connected to the multimedia interface by sensing a voltage level present on an input power pin associated with each HDMI™ input port.

20. The electronic device as recited in claim 15, wherein the multimedia interface is integrated within the electronic device.

21. The electronic device as recited in claim 15, wherein the multimedia interface is a stand-alone interface coupled to the electronic device via a cable.

22. The electronic device as recited in claim 15, wherein the electronic device is selected from a group comprising televisions, computer monitors and other display devices.

23. The electronic device as recited in claim 15, wherein the source devices coupled to the electronic device comprise any number and combination of source devices selected from a group comprising receivers, amplifiers, DVD players, set-top boxes, game stations, cameras, camcorders, personal media players and other audiovisual devices.
